(19) United States
(12) Patent Application Publication
(10) Pub. No.: US 2025/0124918 A1
(43) Pub. Date: Apr. 17, 2025

(54) CONTENT GENERATION DEVICE, MIXED REALITY DEVICE, CONTENT GENERATION SYSTEM, CONTENT GENERATION METHOD, AND STORAGE MEDIUM

(71) Applicant: KABUSHIKI KAISHA TOSHIBA, Tokyo (JP)

(72) Inventors: Hiroki SHINAGAWA, Yokohama Kanagawa (JP); Sumire NISHIJIMA, Kodaira Tokyo (JP); Yukino MASUI, Yokohama Kanagawa (JP); Ren YAMASHITA, Yokohama Kanagawa (JP); Takanori YOSHII, Kawasaki Kanagawa (JP); Kyotaro HAYASHI, Yokohama Kanagawa (JP); Hiroaki NAKAMURA, Kawasaki Kanagawa (JP); Yoshiyuki HIRAHARA, Mishima Shizuoka (JP); Masamitsu FUKUDA, Yokohama Kanagawa (JP); Takafumi KOZAKAI, Ota Tokyo (JP); Yasuo NAMIOKA, Nerima Tokyo (JP)

(21) Appl. No.: 18/882,371

(22) Filed: Sep. 11, 2024

(30) Foreign Application Priority Data
Oct. 11, 2023 (JP) 2023-176285

(51) Int. Cl. G10L 15/22; G06T 19/00

(52) U.S. Cl. CPC G10L 15/22; G06T 19/006

(57) ABSTRACT

According to one embodiment, a content generation device is configured to recognize a voice of a worker when performing a task. The content generation device is configured to generate an instruction related to the task based on a recognition result of the voice. The content generation device is configured to associate the instruction with data of the task and record the instruction. Preferably, the content generation device is configured to generate a prompt by using the recognized voice. The content generation device is configured to acquire a summary of the voice by inputting the prompt to a language model, the language model including a neural network, and record the summary as the instruction.

### CROSS-REFERENCE TO RELATED APPLICATIONS

This application is based upon and claims the benefit of priority from Japanese Patent Application No. 2023-176285, filed on Oct. 11, 2023; the entire contents of which are incorporated herein by reference.

### FIELD

Embodiments of the invention generally relate to a content generation device, a mixed reality device, a content generation system, a content generation method, and a storage medium.

### BACKGROUND

When a novice performs a task with little knowledge or experience, it is desirable for an expert to be able to instruct the novice. For example, the task may be performed while the expert instructs a newcomer. To save manpower or conserve energy when instructing, it is favorable to automate at least a part of the instruction. To automate the instruction, it is necessary to prepare content including instructions relating to the task beforehand. Technology is desirable in which the time and effort necessary to prepare the content can be reduced.

### BRIEF DESCRIPTION OF THE DRAWINGS

FIG. 1 is a block diagram illustrating functions of a content generation device according to an embodiment;

FIG. 2 is a schematic view illustrating a task;

FIGS. 3A and 3B are schematic views illustrating the task;

FIGS. 4A and 4B are figures for describing processing according to the content generation device according to the embodiment;

FIGS. 5A and 5B are figures for describing processing according to the content generation device according to the embodiment;

FIGS. 6A and 6B are figures for describing processing according to the content generation device according to the embodiment;

FIG. 7 is a table illustrating data registered in a database;

FIG. 8 is a flowchart showing a content generation method according to the embodiment;

FIGS. 9A and 9B are figures for describing processing according to the content generation device according to the embodiment;

FIG. 10 is a schematic view illustrating a content generation system according to the embodiment;

FIG. 11 is a schematic view illustrating a mixed reality device;

FIG. 12 is a schematic view illustrating a work site;

FIG. 13 is a schematic view showing an output example of the mixed reality device according to the embodiment;

FIG. 14 is a schematic view showing an output example of the mixed reality device according to the embodiment;

FIG. 15 is a schematic view illustrating a task;

FIG. 16 is a schematic view showing an example of a tool;

FIG. 17 is a schematic view illustrating a task;

FIG. 18 is a drawing for describing a method for calculating a center coordinate; and

FIG. 19 is a schematic view showing a hardware configuration.

### DETAILED DESCRIPTION

Hereinafter, embodiments of the invention will be described with reference to the drawings. The drawings are schematic or conceptual, and the relationship between the thickness and width of each portion, the proportions of sizes among portions, and the like are not necessarily the same as the actual values. Even the dimensions and proportion of the same portion may be illustrated differently depending on the drawing. In the specification and drawings, components similar to those already described are marked with like reference numerals, and a detailed description is omitted as appropriate.

According to an embodiment of the invention, an instruction of a task is generated based on a voice of the worker when the task is performed. After the instruction related to the task is generated, another worker refers to the instruction when performing the task. As a result, an inexperienced worker can perform the task more efficiently or more safely.

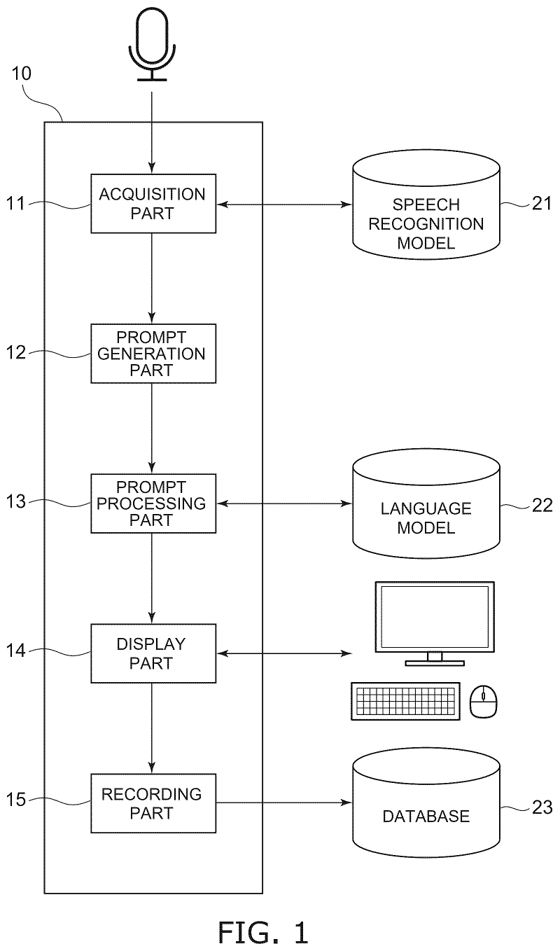

FIG. 1 is a block diagram illustrating functions of a content generation device according to the embodiment.

As shown in FIG. 1, the content generation device 10 functions as an acquisition part 11, a prompt generation part 12, a prompt processing part 13, a display part 14, and a recording part 15.

The content generation device 10 is connected with an audio input device such as a microphone, etc. The acquisition part 11 acquires a voice input to the audio input device. The acquisition part 11 may acquire voice data stored in a server of a network, etc. The voice includes speech content of a worker performing a task. The acquired voice may further include a voice before starting the task or after finishing the task.

The acquisition part 11 recognizes the acquired voice. The voice data is converted into text data by speech recognition. For example, the acquisition part 11 uses a speech recognition model 21 including a neural network. The speech recognition model 21 includes an acoustic model, a language model, etc., and outputs text data according to the voice input. The acquisition part 11 inputs the voice to the speech recognition model 21 and acquires the text data output from the speech recognition model 21.

The prompt generation part 12 and the prompt processing part 13 have the function of generating a more understandable or more appropriate instruction from the recognized voice. The recognized voice may include elements other than the instruction related to the task such as calling out, a response, shouting, etc. The content other than the instruction is unessential for the task. The prompt generation part 12 generates a prompt for summarizing the recognition result of the voice. The summary succinctly expresses the instruction related to the task.

For example, the prompt generation part 12 generates the prompt for summarizing the recognition result according to a preset rule. The prompt processing part 13 inputs the generated prompt to a language model 22 that is prepared beforehand. A large-scale language model (e.g., ChatGPT) that includes a neural network is favorably used as the language model 22. The language model 22 processes the prompt that is input. The prompt processing part 13 acquires the summary output from the language model 22.

The display part 14 causes a display device to display the summary so that a user can check the summary. The user is, for example, a person related to generating the content, and is an expert experienced with the task. The user can correct the displayed summary by using the input device. The display part 14 accepts the correction of the summary.

The summary that is acquired by the prompt processing part 13 or the summary that is corrected by the user corresponds to the instruction related to the task. When the summary is not corrected, the recording part 15 associates the summary output from the language model 22 with the data of the task and records the summary in a database 23. When the summary is corrected, the recording part 15 associates the summary after the correction with the data of the task and records the summary in the database 23.

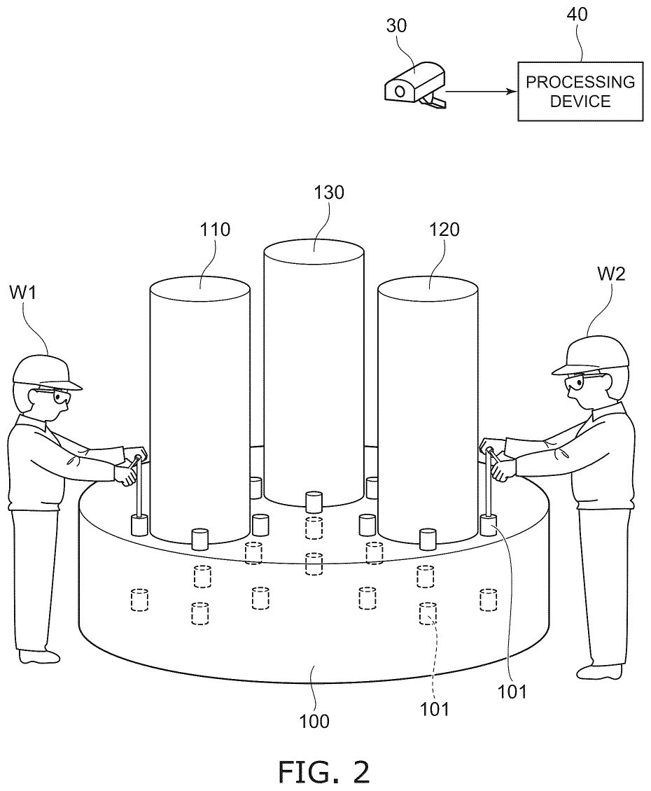

FIG. 2 is a schematic view illustrating a task.

In the example shown in FIG. 2, two persons, i.e., workers W1 and W2, are performing a screw-tightening task on an article 100. Cylindrical members 110 to 130 are placed on the disk-shaped article 100. Fastening locations 101 (screw holes) for fixing the members 110 to 130 are present at the lower surface and upper surface of the article 100. The workers W1 and W2 sequentially turn the screws at the fastening locations 101.

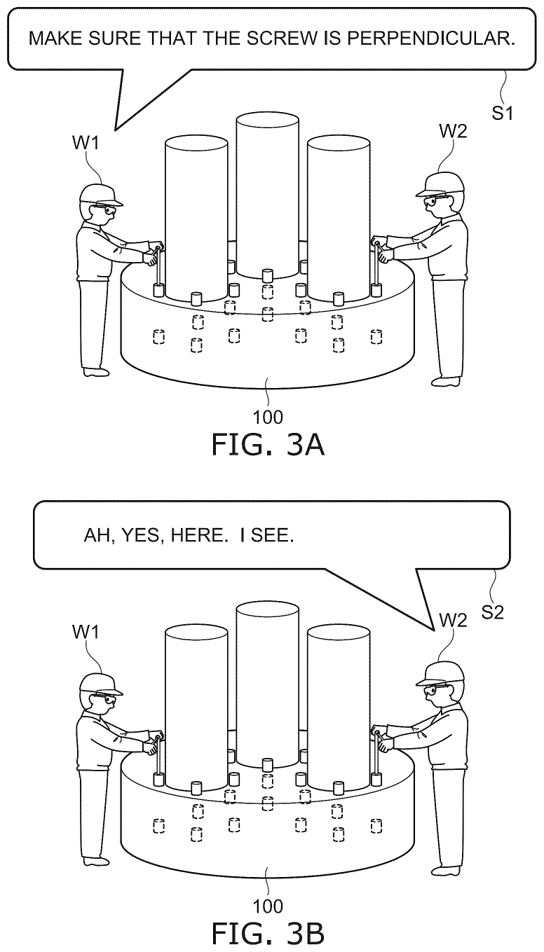

FIGS. 3A and 3B are schematic views illustrating the task.

As an example, the worker W1 is an expert experienced with the task; and the worker W2 is a newcomer inexperienced with the task. When performing the task, the worker W1 proceeds with the task while speaking to the worker W2. For example, as shown in FIG. 3A, the worker W1 instructs the worker W2 to pay attention to the verticality of the screw with an utterance S1. The worker W2 receives the utterance S1 and pays attention to the screw. As shown in FIG. 3B, the worker W2 replies to the utterance S1 with an utterance S2.

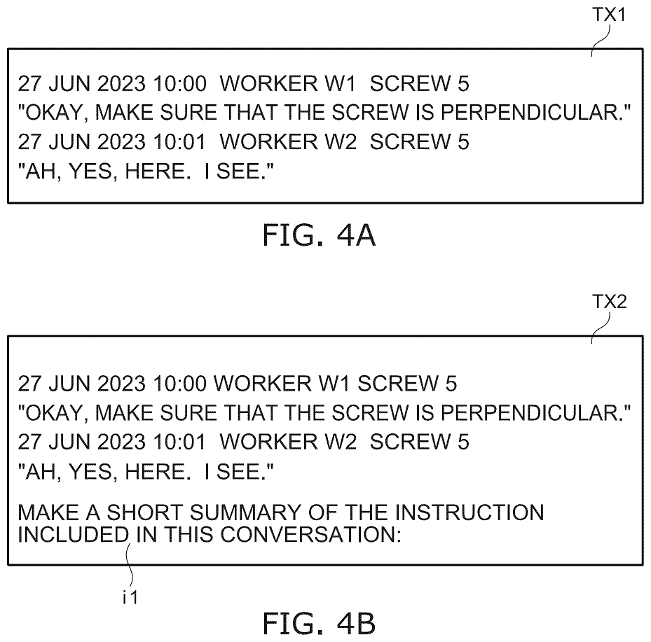

FIGS. 4A, 4B, 5A, 5B, 6A, and 6B are figures for describing processing according to the content generation device according to the embodiment.

The utterances S1 and S2 shown in FIGS. 3A and 3B are acquired by the audio input device. The acquisition part 11 acquires voice data from the audio input device and inputs the voice data to the speech recognition model 21. The time and date at which the voice was acquired, etc., may be added to the voice data. When the utterance by the worker W1 and the utterance by the worker W2 are acquired by different audio input devices, information of the device that acquired the voice may be added to the voice data. When the workers that use each device are preregistered, the acquisition part 11 can identify the worker emitting the voice based on information of the device.

The acquisition part 11 acquires text output from the speech recognition model 21. The acquisition part 11 adds the time and date at which the voice was acquired and information of the worker that emitted the voice to the acquired text, and generates text TX1 shown in FIG. 4A. In the text TX1, the text data based on the utterance S1 is associated with the worker W1; and the text data based on the utterance S2 is associated with the worker W2.

As shown in FIG. 4B, the prompt generation part 12 adds instruction text i1 for generating the summary from the text TX1. Text (a prompt) TX2 for generating the summary is generated thereby.

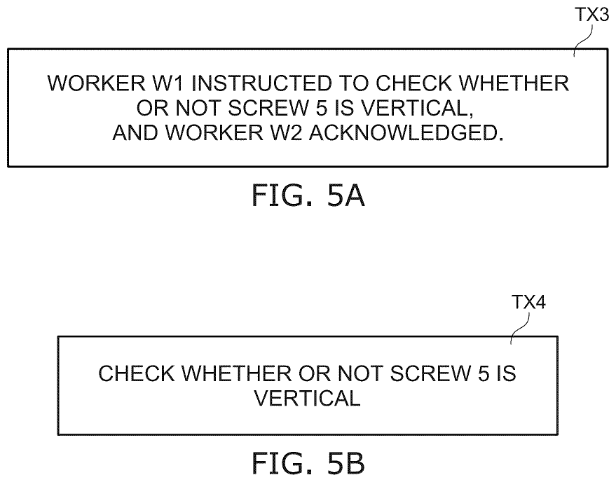

The prompt processing part 13 inputs the text TX2 to the language model 22. The prompt processing part 13 acquires the result output from the language model 22. As an example, text TX3 shown in FIG. 5A is output from the language model 22. The display part 14 displays the text TX3 toward the user, and accepts a correction from the user. For example, the user deletes a part of the text TX3 to shorten the text TX3. As a result, as shown in FIG. 5B, corrected text TX4 is input. The prompt processing part 13 accepts the correction; and the recording part 15 associates the corrected summary with the task, and records the corrected summary.

In the correction of the summary, the user may directly edit the summary, or may input a prompt for correcting the summary. In such a case, the prompt processing part 13 accepts the prompt that is input. The prompt processing part 13 inputs the prompt from the user to the language model 22 and acquires the output result from the language model 22. The display part 14 redisplays the output result toward the user. For example, the correction of the summary is repeated until the user determines that a correction is unnecessary.

The recorded content (instruction) is utilized the next time that the same task is performed. For example, when the worker W2 or another newcomer performs the task on the article 100, the recorded instruction is automatically output. The instruction may be output as a voice or may be displayed.

When generating the prompt, the prompt generation part 12 may delete a part of the text from the recognition result of the voice. For example, the start date that each worker was involved with the task is registered in the database 23. The prompt generation part 12 refers to the start date of each worker related to the task being performed. The prompt generation part 12 calculates the period from the start date to the current date, and compares the period with a preset threshold. When the period is less than the threshold, the prompt generation part 12 determines the worker to be a newcomer. When the period is not less than the threshold, the prompt generation part 12 determines the worker to be an expert. The prompt generation part 12 deletes the text based on the utterance of the newcomer from the recognition result of the voice.

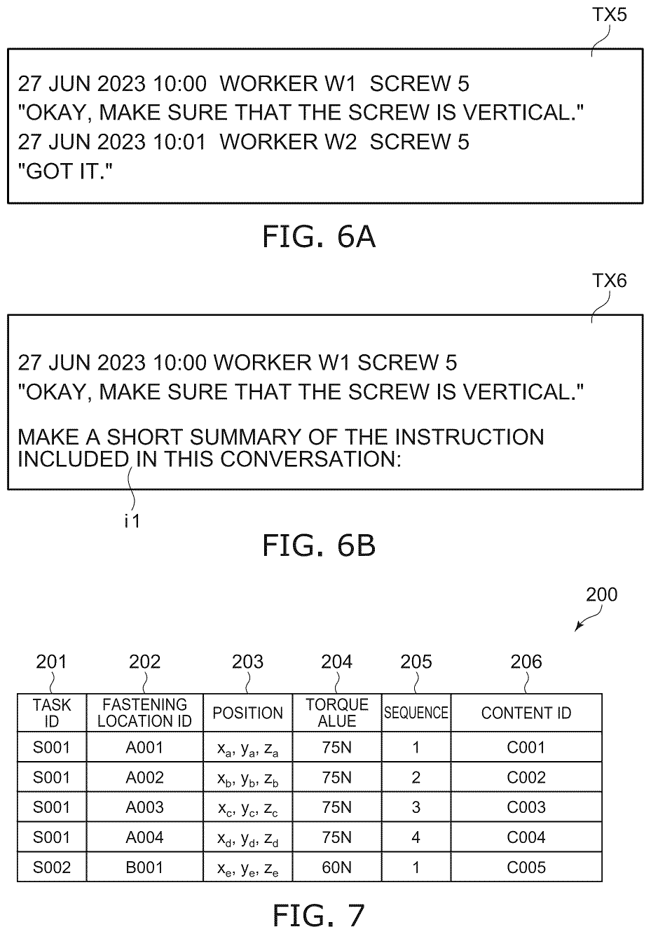

As an example, as shown in FIG. 6A, the recognition results of the voices are associated with the workers; and text TX5 is generated. The prompt generation part 12 refers to the task start dates of the workers W1 and W2. As a result, the worker W1 is determined to be an expert; and the worker W2 is determined to be a newcomer. As shown in FIG. 6B, the prompt generation part 12 generates text TX6 by deleting the utterance of the worker W2.

Or, the prompt generation part 12 may calculate the period from the start date to the current date for each worker, determine workers having longer periods to be experts, and determine workers having shorter periods to be newcomers. When three or more workers are present, the prompt generation part 12 determines that the worker having the longest period is an expert, and determines that the worker having the shortest period is a newcomer. The other workers may be determined to be experts or may be determined to be newcomers.

Or, more directly, data that indicates the proficiencies of the workers may be registered in the database 23. The prompt generation part 12 refers to the preregistered proficiencies and deletes text based on utterances of newcomers.

FIG. 7 is a table illustrating data registered in the database.

The table 200 shown in FIG. 7 is stored in the database 23. The content that is generated by the content generation device 10 is associated with the tasks in the table 200. Specifically, the table 200 includes a task ID 201, a fastening location ID 202, a position 203, a torque value 204, a sequence 205, and a content ID 206. The task ID 201 includes the ID of the task including the screw-tightening at the fastening location 101. The fastening location ID 202 includes the ID of the location at which the screw is tightened. The position 203 is the coordinate of the fastening location designated by the fastening location ID. The torque value 204 is the torque value necessary for the screw-tightening at each fastening location. The sequence 205 is the tightening sequence at multiple fastening locations tightened in one task. The content ID 206 includes the ID for designating the content generated by the content generation device 10.

The task that is associated with the generated instruction is designated by the worker. Or, the task that is being performed may be automatically estimated, and the instruction may be associated with the estimated task. For example, as shown in FIG. 2, an imaging device 30 is mounted in the work site. The imaging device 30 acquires an image by imaging the task. The imaging device 30 may acquire continuous images (a video image). A processing device 40 receives the image acquired by the imaging device 30. Based on the image, the processing device 40 estimates the task being performed, the start of the task, the end of the task, etc. A known method can be utilized as the estimation method using the image.

As an example, when the task to be performed is known, the processing device 40 estimates the pose (the skeleton information) of the worker based on the image. A pose estimation model such as OpenPose, DarkPose, CenterNet, or the like can be used to estimate the pose. The processing device 40 acquires the change of the position of a part of the skeleton as time-series data. The processing device 40 extracts a characteristic pattern (a motif) from the time-series data, and uses the time-series data and the motif to estimate the task being performed, the start of the task, and the end of the task. Such an estimation method is discussed in JP-A 2022-003491 (Kokai).

As another example, the processing device 40 estimates the pose of the worker, the position of the article, the orientation of the article, the state of the article, etc., based on the image. A pose estimation model is used to estimate the pose. The position of the article is estimated by template matching. The movement amount of the article is calculated based on images that are acquired repeatedly, and the orientation of the article is estimated from the movement amount with respect to a preset initial state. The state of the article is estimated using a pretrained state estimation model. Based on the estimation results, the processing device 40 estimates the task being performed, the start of the task, and the end of the task. Such an estimation method is discussed in JP-A 2023-111521 (Kokai).

The content generation device 10 receives the estimation results of the task being performed, the start of the task, the end of the task, etc., from the processing device 40. The content generation device 10 uses the voice from the start of the task to the end of the task to generate the instruction. The content generation device 10 associates the instruction with data of the estimated task and records the instruction.

The content generation device 10 and the processing device 40 are connected via wired communication, wireless communication, a network, etc. The imaging device 30 and the processing device 40 are connected via wired communication, wireless communication, a network, etc.

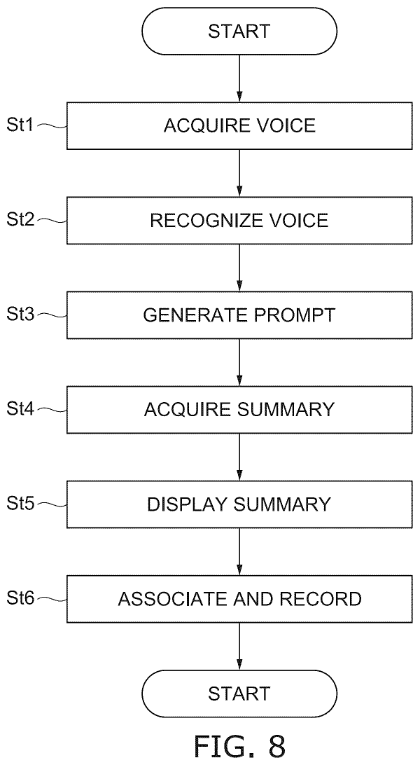

FIG. 8 is a flowchart showing the content generation method according to the embodiment.

First, a voice during the task is input to the audio input device; and the acquisition part 11 acquires the voice (step St1). The acquisition part 11 performs speech recognition (step St2). The prompt generation part 12 generates a prompt based on the recognized voice, the association between the voice and the worker, etc. (step St3). The prompt processing part 13 inputs the prompt to the language model 22 and acquires a summary output from the language model 22 (step St4). The display part 14 displays the summary (step St5). The display part 14 accepts a correction of the summary as appropriate. The recording part 15 associates the summary (the instruction) with the task data and records the summary (the instruction) in the database 23 (step St6).

Advantages of the embodiment will now be described.

When the voice is acquired, the content generation device 10 according to the embodiment generates an instruction related to the task based on the recognition result of the voice. Then, the content generation device 10 associates the instruction with data of the task and records the instruction. As a result, the instruction that is associated with the task can be output from the next time the task is performed.

For example, according to the embodiment as shown in FIGS. 3A and 3B, the instruction is automatically generated based on the utterances when the expert actually instructs. The generated instruction is associated with the task being performed at that time. The instruction is automatically prepared for each task without the expert preparing the instructions and without conscious effort to associate the instruction and the task, etc. Therefore, the instruction of the task can be easily prepared even when the worker is inexperienced with content generation.

After the instruction is prepared, the instruction is automatically output when the same task is performed. As a result, even an inexperienced worker can efficiently perform the task according to the instruction. The task to be performed may be designated by the worker, or may be automatically estimated by the methods described above.

The recognition result of the voice may be recorded as the instruction related to the task, but it is more favorable for a summarized recognition result to be recorded as the instruction. By generating the summary, at least a part of the content other than the instruction is omitted from the recognition result of the voice. By summarizing, the instruction related to the task can be succinctly expressed. As a result, a more understandable or more appropriate instruction can be generated.

As shown in FIG. 7, the content that includes the instruction may be associated with the fastening locations in more detail. In such a case, when a screw is turned at a specific fastening location, the instruction that is associated with the fastening location is automatically output. It is easier for an inexperienced worker to ascertain the instructed content; and the task can be performed more efficiently.

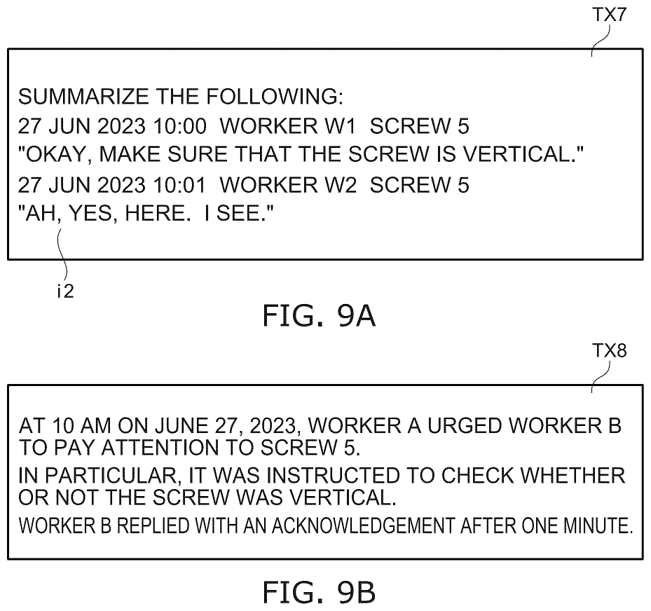

FIGS. 9A and 9B are figures for describing processing according to the content generation device according to the embodiment.

The prompt generation part 12 may generate multiple prompts. For example, when the text TX1 shown in FIG. 4A is acquired, the prompt generation part 12 adds instruction text i2 that is different from the example shown in FIG. 4B, as shown in FIG. 9A. The instruction text i2 is for generating a longer summary (work instruction) than the instruction text i1. Text TX7 is generated thereby.

The prompt processing part 13 inputs the text TX7 to the language model 22, and acquires text TX8 output from the language model 22 as shown in FIG. 9B. The display part 14 displays the text TX8 toward the user, and accepts a correction from the user. The recording part 15 associates the text TX8 output from the language model 22 or the text TX8 corrected by the user with the task and records the associated text.

The character count included in the text TX8 is more than the character count included in the text TX3. Therefore, the text TX8 includes more information than the text TX3. For example, the worker W2 reads the text TX8 after the task is finished to reconfirm the task. Or, another worker reconfirms the task by reading the text TX8 before the task. The text TX8 may not be output the next time the same task is performed. According to such a method, multiple content having different applications can be generated based on one set of voice data.

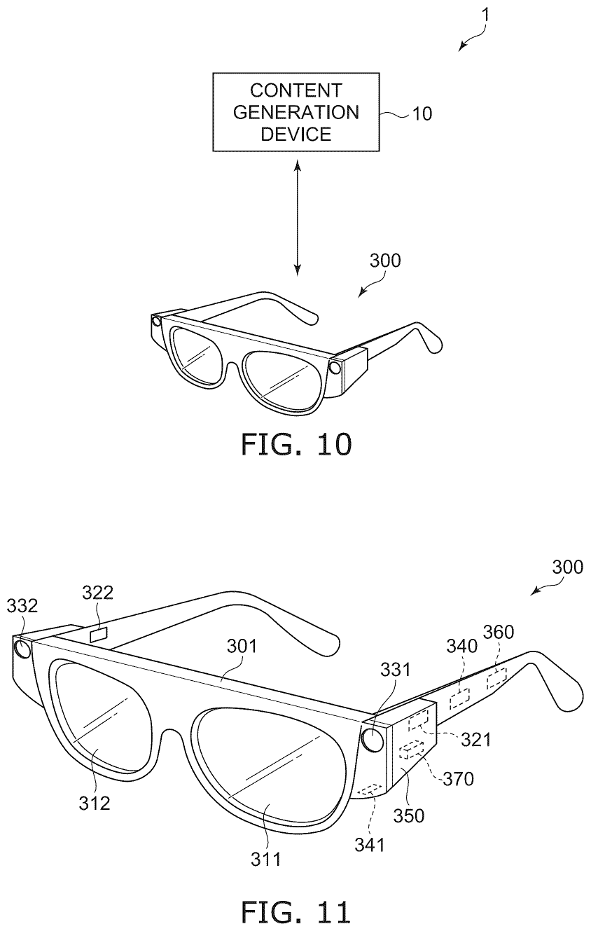

FIG. 10 is a schematic view illustrating a content generation system according to the embodiment.

The content generation device according to the embodiment can be used in cooperation with a mixed reality device (MR). As shown in FIG. 10, the content generation system 1 according to the embodiment includes the content generation device 10 and an MR device 300. The MR device 300 acquires the voice of the worker. The content generation device 10 uses the acquired voice to generate content. The MR device 300 outputs the content toward the worker. The MR device 300 functions as the imaging device 30 and the processing device 40 shown in FIG. 2.

FIG. 11 is a schematic view illustrating the mixed reality device.

The MR device 300 includes a frame 301, a lens 311, a lens 312, a projection device 321, a projection device 322, an image camera 331, a depth camera 332, a sensor 340, a microphone 341, a processing device 350, a battery 360, and a storage device 370.

According to the illustrated example, the MR device 300 is a binocular head mounted display. Two lenses, i.e., the lens 311 and the lens 312, are fit into the frame 301. The projection device 321 and the projection device 322 respectively project information to the lens 311 and the lens 312.

The projection device 321 and the projection device 322 display the recognition result of the body of the worker, virtual objects, etc., on the lenses 311 and 312. Only one of the projection device 321 or the projection device 322 may be included; and information may be displayed on only one of the lens 311 or the lens 312.

The lens 311 and the lens 312 are light-transmissive. The wearer of the MR device 300 can visually recognize reality via the lenses 311 and 312. Also, the wearer of the MR device 300 can visually recognize the information projected onto the lenses 311 and 312 by the projection devices 321 and 322. Information (a virtual space) is displayed to overlap real space by the projection by the projection devices 321 and 322.

The image camera 331 obtains a two-dimensional image by detecting visible light. The depth camera 332 irradiates infrared light and obtains a depth image based on the reflected infrared light. The sensor 340 is a six-axis detection sensor and is configured to detect angular velocities in three axes and accelerations in three axes. The microphone 341 accepts audio input.

The processing device 350 controls components of the MR device 300. For example, the processing device 350 controls the display by the projection devices 321 and 322. The processing device 350 detects movement of the visual field based on the detection result of the sensor 340. The processing device 350 changes the display by the projection devices 321 and 322 according to the movement of the visual field. Otherwise, the processing device 350 is configured to perform various processing by using data obtained from the image camera 331 and the depth camera 332, data of the storage device 370, etc.

The battery 360 supplies power necessary for the operations to the components of the MR device 300. The storage device 370 stores data necessary for the processing of the processing device 350, data obtained by the processing of the processing device 350, etc. The storage device 370 may be located outside the MR device 300, and may communicate with the processing device 350.

The MR device that is used is not limited to the illustrated example and may be a monocular head mounted display. The MR device may be an eyeglasses-type as illustrated, or may be a helmet-type.

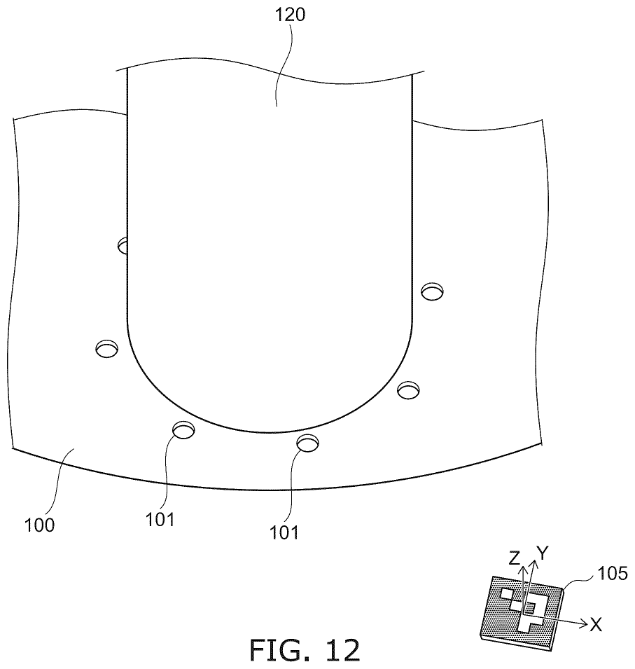

FIG. 12 is a schematic view illustrating a work site.

FIG. 12 shows a task when viewed by the worker W2. The workers W1 and W2 each wear the MR devices 300 shown in FIG. 11. The workers W1 and W2 use wrenches and extension bars to turn screws at the fastening locations 101 of the article 100.

A marker 105 is located proximate to the task object. The marker 105 is an AR marker. As described below, the marker 105 is provided for setting the origin of a three-dimensional coordinate system. Instead of the AR marker, a one-dimensional code (a barcode), a two-dimensional code (a QR code (registered trademark)), etc., may be used as the marker 105. Or, instead of a marker, the origin may be indicated by a hand gesture. The processing device 350 sets the three-dimensional coordinate system referenced to multiple points indicated by the hand gesture.

When starting the task, the image camera 331 and the depth camera 332 image the marker 105. The processing device 350 recognizes the marker 105 based on the imaged image. The processing device 350 sets the three-dimensional coordinate system referenced to the position and orientation of the marker 105.

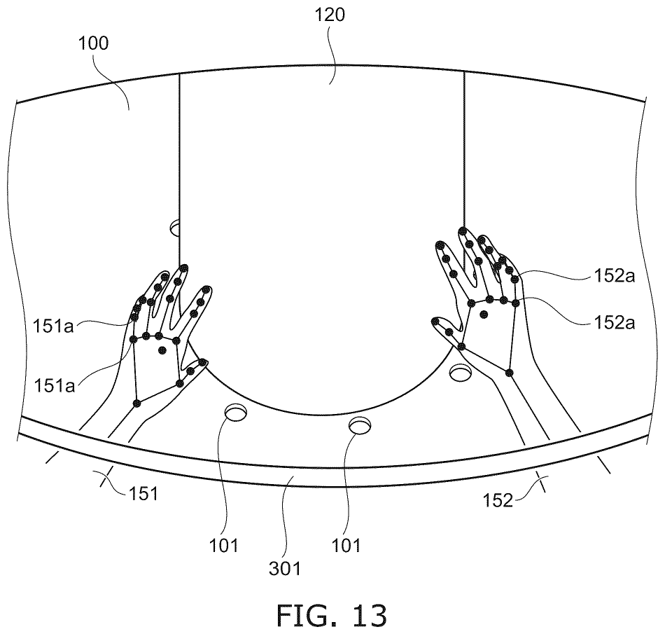

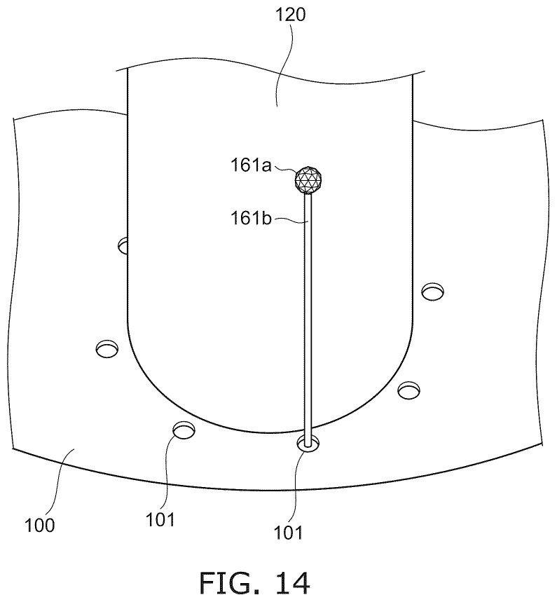

FIGS. 13 and 14 are schematic views showing output examples of the mixed reality device according to the embodiment.

In the task, the image camera 331 and the depth camera 332 image the article 100, a left hand 151 of the worker, and a right hand 152 of the worker. The processing device 350 uses hand tracking to recognize the left and right hands 151 and 152 based on the imaged image. The processing device 350 may cause the projection devices 321 and 322 to display the recognition result on the lenses 311 and 312. Hereinafter, the processing device using the projection device to display information on the lens also is called simply “processing device displaying information”.

For example, as shown in FIG. 13, the processing device 350 displays the recognition result of the left hand 151 and the recognition result of the right hand 152 to overlap the hands in real space. According to the illustrated example, multiple virtual objects 151a and multiple virtual objects 152a are displayed as the recognition results of the left and right hands 151 and 152. The multiple virtual objects 151a respectively indicate multiple joints of the left hand 151. The multiple virtual objects 152a respectively indicate multiple joints of the right hand 152. Instead of joints, virtual objects (meshes) that represent the surface shape of the left hand 151 and the surface shape of the right hand 152 may be displayed.

When the left hand 151 and the right hand 152 are recognized, the processing device 350 measures the coordinates of the hands. Specifically, each hand includes multiple joints such as a DIP joint, a PIP joint, an MP joint, a CM joint, etc. The coordinates of any of these joints are used as the coordinate of the hand. The centroid position of the multiple joints may be used as the coordinate of the hand. Or, the center coordinate of the entire hand may be used as the coordinate of the hand.

As shown in FIG. 14, the processing device 350 may display virtual objects 161a and 161b. The virtual objects 161a and 161b are displayed to correspond to one fastening location 101. The virtual object 161a is displayed at a position separated from the fastening location 101. The virtual object 161b is displayed between the fastening location 101 and the virtual object 161a. The virtual object 161b shows which fastening location corresponds to the virtual object 161a.

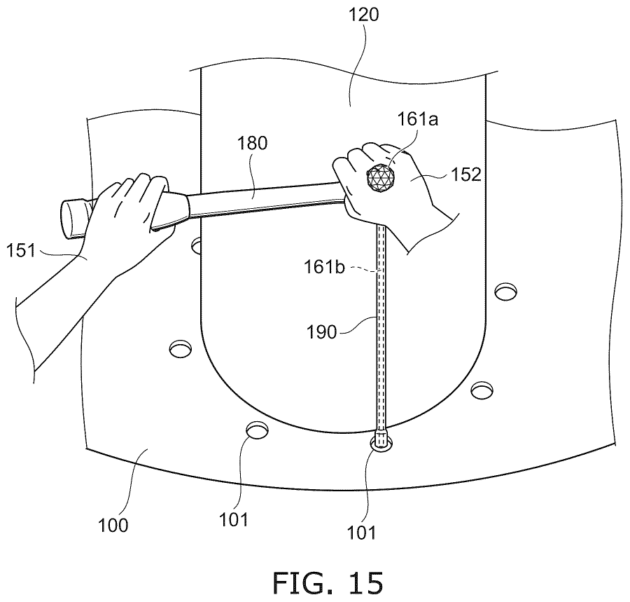

FIG. 15 is a schematic view illustrating a task.

For example, as shown in FIG. 15, a wrench 180 and an extension bar 190 are used to turn a screw at the fastening location 101. When tightening a screw at the fastening location 101, the worker places the screw in the screw hole of the fastening location 101. The worker causes one end of the extension bar 190 to engage the screw. The worker causes the head of the wrench 180 to engage the other end of the extension bar 190. The worker presses the head of the wrench 180 with one hand, and grips the grip of the wrench 180 with the other hand. By turning the wrench 180, the screw is tightened at the fastening location 101 via the extension bar 190.

At this time, the worker disposes the extension bar 190 so that the extension bar 190 approaches or contacts the virtual object 161b. Also, the worker grips the head of the wrench 180 so that the hand contacts the virtual object 161a. By displaying the virtual object, the worker can easily ascertain the positions at which the tool and the hand are to be located when turning the screw at the fastening location 101. The work efficiency can be increased thereby.

According to the illustrated example, the virtual object 161a is spherical, and the virtual object 161b is rod-shaped. The shapes of the objects are not limited to the example as long as the worker can visually recognize the virtual objects. For example, the virtual object 161a may be cubic; and the virtual object 161b may be linear.

The virtual objects 161a and 161b are displayed at preregistered positions in the three-dimensional coordinate system set to be referenced to the marker 105. Or, the positions of the fastening locations 101, data of the tool to be used, etc., may be preregistered; and the display positions of the virtual objects 161a and 161b may be calculated using the data. For example, the virtual object 161b is displayed between the fastening location 101 and a position separated from the fastening location 101 by the length of the extension bar 190. The virtual object 161a is displayed at a position separated from the fastening location 101 by the length of the extension bar 190.

The virtual objects 161a and 161b are sequentially displayed at the fastening locations according to a preset tightening sequence. In other words, after the screw at the fastening location 101 displayed by the virtual objects 161a and 161b is turned, the virtual objects 161a and 161b are displayed at another fastening location 101.

After the virtual objects are displayed, the processing device 350 may determine whether or not a prescribed object contacts a virtual object. For example, the processing device 350 determines whether or not a hand contacts the virtual object 161a. Specifically, the processing device 350 calculates the distance between the virtual object 161a and the coordinate of the hand. When some distance is less than a preset threshold, the processing device 350 determines that the hand contacts the virtual object. As an example in FIG. 14, the diameter of the virtual object 161a (a sphere) corresponds to the threshold. The sphere is the range in which the hand is determined to contact the virtual object.

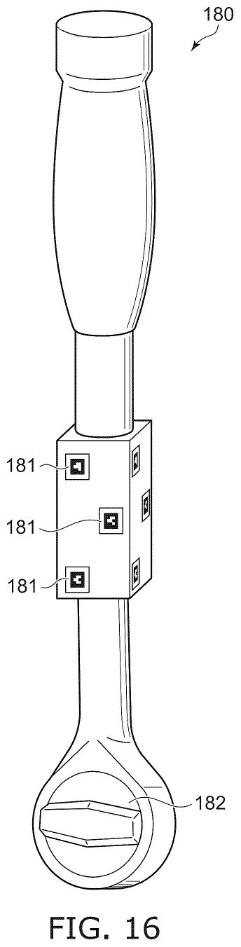

FIG. 16 is a schematic view showing an example of a tool.

The processing device 350 may determine whether or not the tool contacts the virtual object 161a. For example, as shown in FIG. 16, multiple markers 181 are mounted to the wrench 180. The processing device 350 recognizes the multiple markers 181 based on an image that is imaged by the image camera 331. The processing device 350 measures the coordinates of the markers 181. The positional relationships between the multiple markers 181 and a head 182 of the wrench 180 are preregistered. The processing device 350 calculates the coordinate of the head 182 based on the coordinates of at least three markers 181 that are recognized and the preregistered positional relationships. The processing device 350 calculates the distance between the virtual object 161a and the coordinate of the head 182. When the distance is less than a preset threshold, the processing device 350 determines that the wrench 180 contacts the virtual object.

When the distance is less than the threshold, it can be estimated (inferred) that a screw is being turned at a fastening location corresponding to the one of the virtual objects 161a. In the example shown in FIG. 15, due to the contact between the hand and the virtual object 161a, it is estimated that the task is to be performed at the fastening location 101 corresponding to the virtual object 161a.

The start of the task may be estimated based on the distance between the prescribed object and the virtual object. The processing device 350 estimates that the task has started when the distance initially drops below the threshold. After starting the task, the content generation device 10 acquires a voice input to the microphone 341. The content generation device 10 associates an instruction generated based on the voice with data of the fastening location at which the task is estimated to be performed. For example, as shown in FIG. 7, the data of the instruction is associated with the ID of the fastening location. Or, the content generation device 10 may designate the task ID including the screw-tightening to the estimated fastening location, and may associate the instruction with the task ID.

When the start of the task is estimated, the voice may be acquired not only after starting the task, but also during a prescribed period before starting the task. The content generation device 10 associates, with the data of the fastening location, an instruction generated based on the voice before the task start and the voice after the task start. When an expert instructs, there are cases where instructions are uttered before starting the task as well. By also acquiring the voice before starting the task, the instructions generated before starting the task also can be included in the generated content.

For example, after the start of the task is estimated, the processing device 350 estimates that the task is finished when a state in which the distance is greater than the threshold continues longer than a preset time. A digital tool that can detect the torque may be used in the task. In such a case, the processing device 350 receives the torque detected from the tool. When the torque value necessary for each fastening location is preset, the task may be estimated to be finished at the timing at which the necessary torque value is detected by the tool.

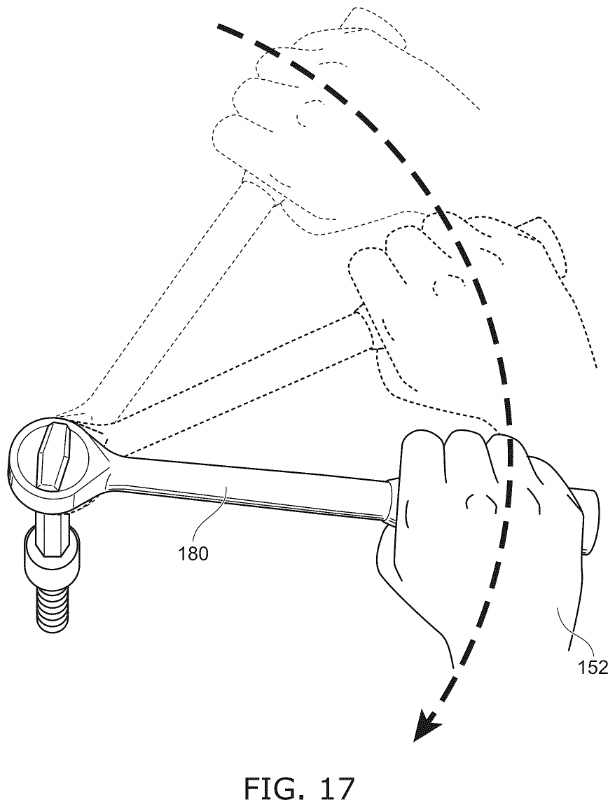

FIG. 17 is a schematic view illustrating a task.

The following other method may be used as the estimation method of the location at which the task is performed and the start of the task. The movement of the hand of the worker is utilized in the other method. The processing device 350 repeatedly measures the coordinate of the hand while the worker turns the wrench 180. At this time, as shown in FIG. 17, the hand is positioned on a circumference centered on a part of the wrench 180. The hand is moved to trace a circular arc. The processing device 350 utilizes this movement to calculate the center coordinate of the rotation of the tool. A specific example of the calculation of the center coordinate will now be described.

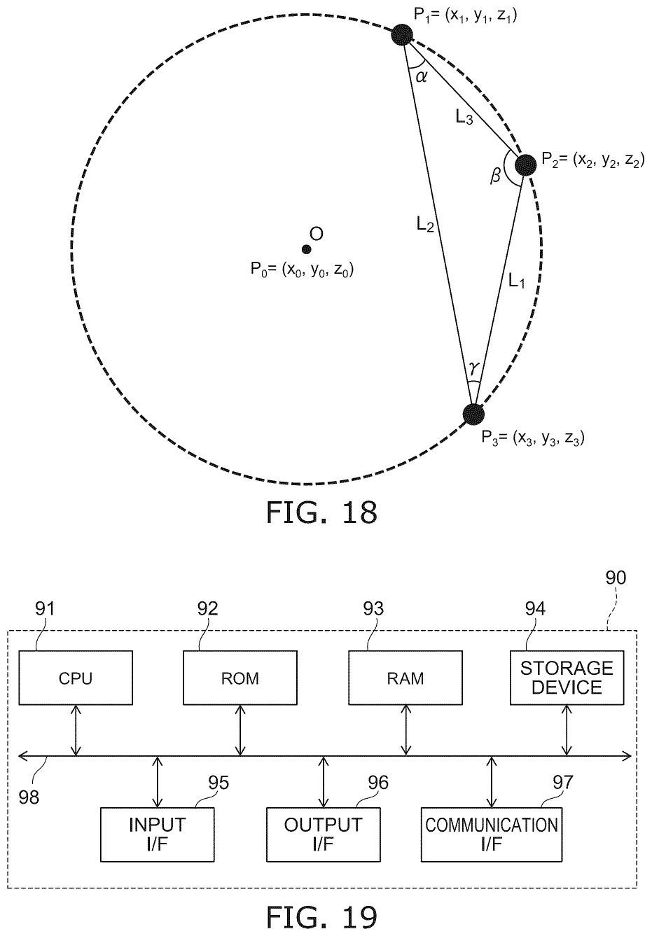

FIG. 18 is a drawing for describing the method for calculating the center coordinate.

The processing device 350 extracts three different coordinates from the measured multiple coordinates. The processing device 350 calculates a circumcenter O of the three coordinates. Here, as shown in FIG. 18, the three coordinates are taken as P₁ (x₁, y₁, z₁), P₂ (x₂, y₂, z₂), and P₃ (x₃, y₃, z₃). The coordinate of the circumcenter O is taken as P₀ (x₀, y₀, z₀). The length of the side opposite to the coordinate P₁ of a triangle obtained by connecting the coordinates P₁ to P₃ is taken as L₁. The length of the side opposite to the coordinate P₂ is taken as L₂. The length of the side opposite to the coordinate P₃ is taken as L₃. The angle at the coordinate P₁ is taken as α. The angle at the coordinate P₂ is taken as β. The angle at the coordinate P₃ is taken as γ. In such a case, the coordinate of the circumcenter O is represented by the following Formula (1). In Formula (1), the symbols marked with arrows represent position vectors. Formula (1) can be rewritten as Formula (2). Formula (2) can be broken down into Formulas (3) to (5).

$$\vec{{P}_{0}} = \frac{\begin{matrix}{L}_{1}^{2} ( {L}_{2}^{2} + {L}_{3}^{2} - {L}_{1}^{2} ) \vec{P 1} + \\ {L}_{2}^{2} ( {L}_{3}^{2} + {L}_{1}^{2} - {L}_{2}^{2} ) \vec{P 2} + {L}_{3}^{2} ( {L}_{1}^{2} + {L}_{2}^{2} - {L}_{3}^{2} ) \vec{P 3}\end{matrix}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 1 ]$$

$$( {x}_{0} , {y}_{0} , {z}_{0} ) = \frac{\begin{matrix}\begin{matrix}{L}_{1}^{2} ( {L}_{2}^{2} + {L}_{3}^{2} - {L}_{1}^{2} ) ( {x}_{1} , {y}_{1} , {z}_{1} ) + \\ {L}_{2}^{2} ( {L}_{3}^{2} + {L}_{1}^{2} - {L}_{2}^{2} ) ( {x}_{2} , {y}_{2} , {z}_{2} ) +\end{matrix} \\ {L}_{3}^{2} ( {L}_{1}^{2} + {L}_{2}^{2} - {L}_{3}^{2} ) ( {x}_{3} , {y}_{3} , {z}_{3} )\end{matrix}}{\begin{matrix}{L}_{1}^{2} ( {L}_{2}^{2} + {L}_{3}^{2} - {L}_{1}^{2} ) + \\ {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )\end{matrix}} \qquad [ Formula 2 ]$$

$${x}_{0} = \frac{\begin{matrix}{L}_{1}^{2} ( {L}_{2}^{2} + {L}_{3}^{2} - {L}_{1}^{2} ) {x}_{1} + \\ {L}_{2}^{2} ( {L}_{3}^{2} + {L}_{1}^{2} - {L}_{2}^{2} ) {x}_{2} + {L}_{3}^{2} ( {L}_{1}^{2} + {L}_{2}^{2} - {L}_{3}^{2} ) {x}_{3}\end{matrix}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 3 ]$$

$${y}_{0} = \frac{\begin{matrix}{L}_{1}^{2} ( {L}_{2}^{2} + {L}_{3}^{2} - {L}_{1}^{2} ) {y}_{1} + \\ {L}_{2}^{2} ( {L}_{3}^{2} + {L}_{1}^{2} - {L}_{2}^{2} ) {y}_{2} + {L}_{3}^{2} ( {L}_{1}^{2} + {L}_{2}^{2} - {L}_{3}^{2} ) {y}_{3}\end{matrix}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 4 ]$$

$${z}_{0} = \frac{\begin{matrix}{L}_{1}^{2} ( {L}_{2}^{2} + {L}_{3}^{2} - {L}_{1}^{2} ) {z}_{1} + \\ {L}_{2}^{2} ( {L}_{3}^{2} + {L}_{1}^{2} - {L}_{2}^{2} ) {z}_{2} + {L}_{3}^{2} ( {L}_{1}^{2} + {L}_{2}^{2} - {L}_{3}^{2} ) {z}_{3}\end{matrix}}{{L}_{1}^{2} ( {L}_{2}^{2} + {L}_{3}^{2} - {L}_{1}^{2} ) + {L}_{2}^{2} ( {L}_{3}^{2} + {L}_{1}^{2} - {L}_{2}^{2} ) + {L}_{3}^{2} ( {L}_{1}^{2} + {L}_{2}^{2} - {L}_{3}^{2} )} \qquad [ Formula 5 ]$$

x₀, y₀, z₀ are calculated from Formulas (3) to (5). The processing device 350 calculates the coordinate P₀ (x₀, y₀, z₀) of the circumcenter O as the center coordinate of the rotation of the wrench 180.

The processing device 350 may extract multiple combinations of three coordinates. The processing device 350 calculates the coordinate of the circumcenter for each combination. The processing device 350 calculates the median value, average value, or mode of the multiple coordinates as the center coordinate of the rotation of the wrench 180. As a result, the accuracy of the calculated center coordinate can be increased.

Before performing the method described above, some coordinates may be selected from the multiple coordinates of the hand. The calculation described above is performed using the selected coordinates. For example, only the coordinates estimated to be when the hand is moving in an arc-like shape are selected; and the coordinates to be used in the calculation are extracted from these coordinates. By using only the coordinates when the hand is moving in the arc-like shape, the accuracy of the center coordinate can be further increased.

As an example, when a digital tool is used, the processing device 350 selects the coordinates of the hand obtained at the timing (the time) at which data is received from the digital tool. When the screw is turned with the digital tool, the digital tool detects the torque value, the rotation angle, etc. The processing device 350 receives the detected values detected by the digital tool. The reception of the detected values indicates that the hand is moving in an arc-like shape. Therefore, the coordinates of the hand obtained at the timing (the time) at which the detected values are received are selected and used to calculate the center coordinate, and so the center coordinate can be calculated with higher accuracy.

The center coordinate of the rotation of the wrench 180 can be considered to be the position of the screw being tightened by the wrench 180. The screw is tightened at a prescribed location of the article. Therefore, by estimating the position of the screw, it can be estimated that the screw at the fastening location most proximate to the center coordinate is being tightened. For example, the processing device 350 calculates the distance between the center coordinate and the fastening location most proximate to the center coordinate, and compares the distance with a preset threshold. When a state in which the distance is less than the threshold continues longer than a preset time, the processing device 350 estimates that the task is being performed on the most proximate fastening location. After it is estimated that the task is being performed, the timing at which the distance initially became less than the threshold can be estimated to be the start of the task.

For example, when a state in which the distance is greater than the threshold continues longer than a preset time, the processing device 350 estimates that the task is finished. When a digital tool is used and the torque value necessary for each fastening location is preset, it may be estimated that the task is finished at the timing at which the necessary torque value is detected by the tool.

When a digital tool is used, the MR device 300 may receive the rotation angle, the torque, the time, etc., from the tool, and may associate the data with the data of the estimated fastening location. As a result, a detailed task record can be automatically generated.

Images that are imaged by the image camera 331 are used in any of estimation methods described above. Based on the images, the position of the hand or the position of the tool is measured and used to determine contact between the prescribed object and the virtual object or to calculate the center coordinate. The determination result of the contact or the calculation result of the center coordinate is used to estimate the task being performed, the start of the task, etc.

According to the content generation system according to the embodiment, by using the MR device 300, even a newcomer can efficiently perform the task. While the task is being performed, the MR device 300 automatically estimates that the task is being performed, estimates the start of the task, etc. The content generation device 10 uses such estimation results to automatically associate the generated instruction with the task. According to embodiments, even an inexperienced worker can efficiently perform the task and automatically generate content including instructions while performing the task.

After the instruction is generated by the content generation device 10, the MR device 300 may output the instruction. For example, the MR device 300 projects the instruction to the lenses 311 and 312. Or, the MR device 300 may output the instruction as a voice from a speaker (not illustrated).

Embodiments of the invention are applicable to a task of loosening a screw. Even when loosening a screw, the screw is turned by using the tool as shown in FIG. 15. In such a case, by using images, the task being performed and the fastening location at which the screw is being turned may be estimated. Based on such estimation results, the content generation device 10 generates an instruction from a voice in the task.

Embodiments of the invention are applicable to tasks other than the task of turning a screw. For example, the task may be the assembly of an article, the dismantling of an article, the transport of an article, etc. In such tasks, the content generation device 10 generates an instruction related to the task by recognizing a voice of a worker. As a result, the instruction that is associated with the task can be output from the next time the task is performed.

FIG. 19 is a schematic view showing a hardware configuration.

For example, a computer 90 shown in FIG. 19 is used as each of the content generation device 10, the processing device 40, and the processing device 350. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory and executes the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes a solid state drive (SSD), etc.

The input interface (I/F) 95 can connect the computer 90 with an input device. The CPU 91 can read various data from the input device via the input I/F 95.

The output interface (I/F) 96 can connect the computer 90 with an output device. The CPU 91 can transmit data to the output device via the output I/F 96 and can cause the output device to output information.

The communication interface (I/F) 97 can connect the computer 90 and a device outside the computer 90. For example, the communication I/F 97 connects a digital tool and the computer 90 by Bluetooth (registered trademark) communication.

The data processing performed by the content generation device 10, the processing device 40, and the processing device 350 may be performed by only one computer 90. A part of the data processing may be performed by a server, etc., via the communication I/F 97. In the example shown in FIGS. 1 and 2, one computer may perform the processing performed by the content generation device 10 and the processing device 40 and may include the functions of both the content generation device 10 and the processing device 40. A part of the processing performed by the processing device 350 in the example shown in FIG. 10 may be performed by the content generation device 10.

Processing of various types of data described above may be recorded, as a program that can be executed by a computer, on a magnetic disk (examples of which include a flexible disk and a hard disk), an optical disk (examples of which include a CD-ROM, a CD-R, a CD-RW, a DVD-ROM, a DVD+R, and DVD+RW), a semiconductor memory, or another non-transitory computer-readable storage medium.

For example, information recorded on a recording medium can be read by a computer (or an embedded system). The recording medium can have any record format (storage format). For example, the computer reads a program from the recording medium and causes the CPU to execute instructions described in the program, on the basis of the program. The computer may obtain (or read) the program through a network.

Embodiments of the invention include the following features.

### Feature 1

A content generation device, configured to:
recognize a voice of a worker when performing a task;
generate an instruction related to the task based on a recognition result of the voice;
associate the instruction with data of the task; and
record the instruction.

### Feature 2

The content generation device according to feature 1, further configured to:
generate a prompt by using the recognized voice;
acquire a summary of the voice by inputting the prompt to a language model, the language model including a neural network; and
record the summary as the instruction.

### Feature 3

The content generation device according to feature 2, further configured to:
accept a correction of the summary from a user; and
record the corrected summary as the instruction when the summary is corrected.

### Feature 4

The content generation device according to any one of features 1 to 3, in which
a screw of an article is turned in the task, and
the voice is acquired after a start of the task is estimated.

### Feature 5

The content generation device according to feature 4, in which the start of the task is estimated using an image of the task.

### Feature 6

The content generation device according to feature 4 or 5, in which
a location at which the screw is turned is estimated,
the instruction is associated with data of the estimated location, and
the instruction is recorded.

### Feature 7

A mixed reality device, configured to:
display a virtual object overlapping a real space; and
output the instruction recorded by the content generation device according to any one of features 1 to 6 when the task is performed.

### Feature 8

A content generation system, including:
the content generation device according to feature 1; and
a mixed reality device configured to display a virtual object overlapping a real space,
a screw of an article being turned in the task, the mixed reality device estimating a location at which the screw is being turned based on a result of hand tracking in the task,
the content generation device associating the instruction with data of the estimated location and recording the instruction.

### Feature 9

A content generation method, including:
causing a computer to:
   recognize a voice of a worker when performing a task;
   generate an instruction related to the task based on a recognition result of the voice;
   associate the instruction with data of the task; and
   record the instruction.

### Feature 10

A program, when executed by a computer, causing the computer to perform the content generation method according to feature 9.

### Feature 11

A storage medium configured to store the program according to feature 10.

According to embodiments above, a content generation device, a mixed reality device, a content generation system, a content generation method, a program, and a storage medium are provided in which an instruction related to the task can be generated more easily.

In the specification, “or” indicates that “at least one or more” of items enumerated in the sentence can be adopted.

Although some embodiments of the invention have been described above, these embodiments have been presented by way of example and are not intended to limit the scope of the invention. These novel embodiments can be implemented in a variety of other forms, and various omissions, substitutions, changes, and the like can be made without departing from the gist of the invention. Such embodiments or their modifications fall within the scope of the invention as defined in the claims and their equivalents as well as within the scope and gist of the invention. Further, the above-described embodiments can be implemented in combination with each other.

What is claimed is:

1. A content generation device, configured to:
recognize a voice of a worker when performing a task;
generate an instruction related to the task based on a recognition result of the voice;
associate the instruction with data of the task; and
record the instruction.

2. The content generation device according to claim 1, further configured to:
generate a prompt by using the recognized voice;
acquire a summary of the voice by inputting the prompt to a language model, the language model including a neural network; and
record the summary as the instruction.

3. The content generation device according to claim 2, further configured to:
accept a correction of the summary from a user; and
record the corrected summary as the instruction when the summary is corrected.

4. The content generation device according to claim 1, wherein
a screw of an article is turned in the task, and
the voice is acquired after a start of the task is estimated.

5. The content generation device according to claim 4, wherein
the start of the task is estimated using an image of the task.

6. The content generation device according to claim 4, wherein
a location at which the screw is turned is estimated,
the instruction is associated with data of the estimated location, and
the instruction is recorded.

7. A mixed reality device, configured to:
display a virtual object overlapping a real space; and
output the instruction recorded by the content generation device according to claim 1 when the task is performed.

8. A content generation system, comprising:
the content generation device according to claim 1; and
a mixed reality device configured to display a virtual object overlapping a real space,
a screw of an article being turned in the task,
the mixed reality device estimating a location at which the screw is being turned based on a result of hand tracking in the task,
the content generation device associating the instruction with data of the estimated location and recording the instruction.

9. A content generation method, comprising:
causing a computer to:
recognize a voice of a worker when performing a task;
generate an instruction related to the task based on a recognition result of the voice;
associate the instruction with data of the task; and
record the instruction.

10. A non-transitory computer-readable storage medium configured to store a program,
the program, when executed by a computer, causing the computer to perform the content generation method according to claim 9.
